(19) United States
(12) Patent Application Publication
(10) Pub. No.: US 2024/0197069 A1
(43) Pub. Date: Jun. 20, 2024

(54) FACIAL BRUSH AND CRADLE

(71) Applicant: CONAIR LLC, Stamford, CT (US)

(72) Inventors: Melissa Jane ZELENZ, Stamford, CT (US); Daniel BISHOP, Trumbull, CT (US); Sophia WOJCZAK, Harrison, NY (US)

(73) Assignee: CONAIR LLC, Stamford, CT (US)

(21) Appl. No.: 18/067,969

(22) Filed: Dec. 19, 2022

(51) Int. Cl. A46B 13/02; A46B 17/08; H02J 50/10

(52) U.S. Cl. CPC A46B 13/02; A46B 17/08; H02J 50/10

(57) ABSTRACT

A facial brush and a cradle system that includes an electrically powered facial brush having at least one moving part that is driven by electrical power and that has a housing, a grip portion and a head portion. The facial brush and a cradle system also has a cradle having a base adapted to rest in a free-standing fashion on a generally flat surface and having a cord for connecting to an external electrical power supply source. The cradle is adapted to support the facial brush in a position in which the facial brush is suspended above the base and the generally flat surface.

### BACKGROUND

### 1. Field of the Disclosure

The present disclosure relates to a facial brush and cradle. In particular, the present disclosure is related to a facial brush that hangs on a cradle.

### 2. Description of Related Art

Facial brushes are available that are electrically powered to treat skin, for example, by cleaning, exfoliating, massaging and/or moisturizing the skin. Typically, a bottom portion of facial brushes rest in or are held in a base. The bottom portion of facial brushes resting in the base has been problematic. For example, the base has electrical contacts for contacting electrical contacts on the facial brush to recharge the facial brush. These electrical contacts in the base can get undesirably covered in moisture, dust, lint and the like. However, the problems relating to the bottom portion of facial brushes resting in the base are not limited to debris, moisture, dust, lint and the like interfering with the charging contacts. A further example of these problems is that the hole/well itself in the base generally collects undesirable debris, liquid, water and the like.

Accordingly, it has been determined by the present disclosure that there is a continuing need for a device that overcomes, alleviates, and/or mitigates one or more of the aforementioned and other deleterious effects of prior devices.

### SUMMARY

The present disclosure has a facial brush that avoids contact with a base and thereby avoids the normal deleterious effects associated with such contact.

The facial brush of the present disclosure hangs (i.e., is suspended) from a cradle rather than resting in a hole in a base. Facial brushes that rest in a base can undesirably include electrical contacts in the base for recharging that can get covered in moisture, dust, lint and the like leading to suboptimal operation and/or include the hole in the base that itself generally collects undesirable debris, liquid, water and the like. The facial brush of the present disclosure hangs from the cradle to avoid those pitfalls.

The present disclosure provides a facial brush and a cradle system that includes an electrically powered facial brush having at least one moving part that is driven by electrical power and that has a housing, a grip portion and a head portion. The facial brush and cradle system also has a cradle having a base adapted to rest in a free-standing fashion on a generally flat surface and having a cord for connecting to an external electrical power supply source. The cradle is adapted to support the facial brush in a position in which the facial brush is suspended above the base and the generally flat surface.

The above-described and other features and advantages of the present disclosure will be appreciated and understood by those skilled in the art from the following detailed description, drawings, and appended claims.

### DESCRIPTION OF THE DRAWINGS

FIG. 1 is a front perspective view of a facial brush hanging on a cradle according to the present disclosure connected to a first attachment.

FIG. 2 is a rear perspective view of the facial brush hanging on the cradle of FIG. 1 connected to the first attachment.

FIG. 3 is a front perspective view of the facial brush of FIG. 1 connected to the first attachment.

FIG. 4 is a rear perspective view of the facial brush of FIG. 1 connected to the first attachment.

FIG. 5 is a front perspective view of the cradle of FIG. 1.

FIG. 6 is a rear perspective view of the cradle of FIG. 1.

FIG. 7 is a rear perspective view of the facial brush of FIG. 1 that is modified to have an inductive charging system and connected to the first attachment.

FIG. 8 is a front perspective view of the cradle of FIG. 1 that is modified to have the inductive charging system.

FIG. 9 is a front perspective view of the facial brush hanging on the cradle of FIG. 1 connected to a second attachment.

FIG. 10 is a front perspective view of the facial brush hanging on the cradle of FIG. 1 connected to a third attachment.

### DETAILED DESCRIPTION

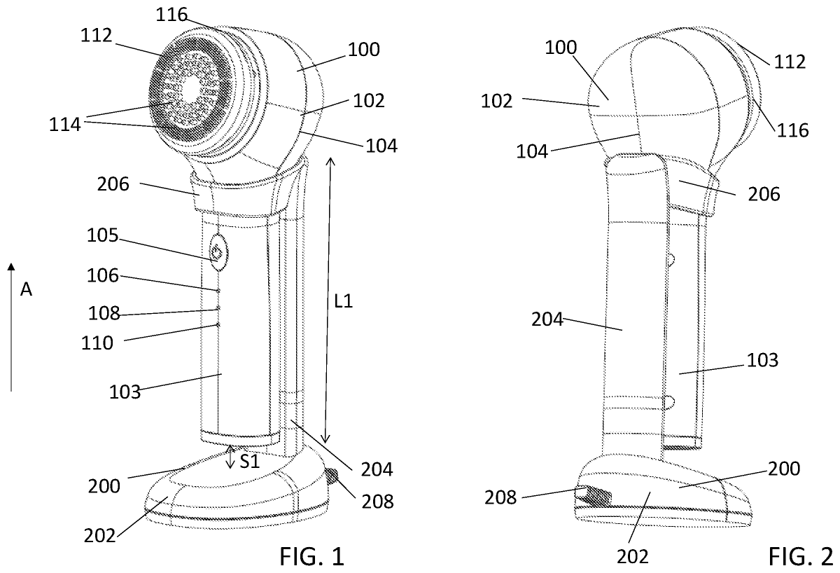

Referring to the drawings and in particular to FIGS. 1 and 2, an exemplary embodiment of facial brush according to the present disclosure is shown and is generally referred to by reference numeral 100 (“device 100”). Facial brush 100 treats skin, for example, by cleaning, exfoliating, massaging and/or moisturizing the skin. Advantageously, facial brush 100 hangs (i.e., is suspended) from a cradle 200 rather than resting in a hole in a base. Facial brushes that rest in a base can undesirably include electrical contacts in the base for recharging that can get covered in moisture, dust, lint and the like leading to suboptimal operation and/or include the hole in the base that itself generally collects undesirable debris, liquid, water and the like. Facial brush 100 that hangs from cradle 200 avoids those pitfalls.

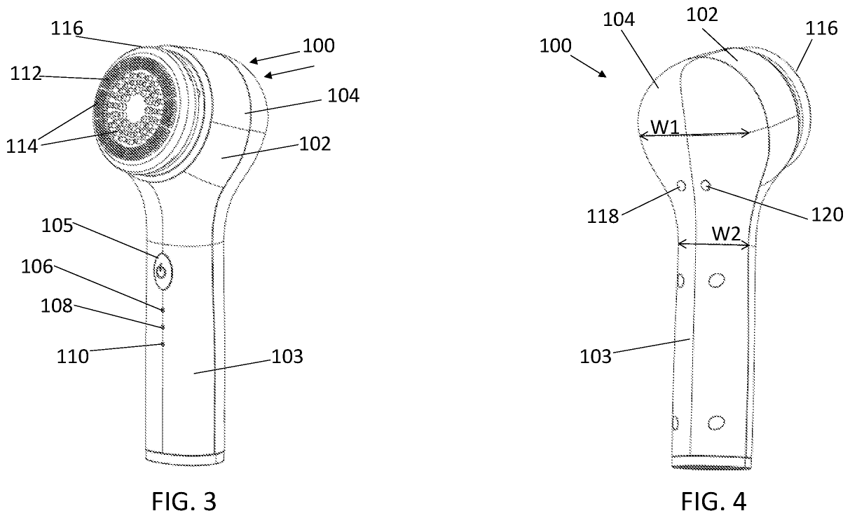

Facial brush 100 has a housing 102. Housing 102 has a grip portion 103 extending from a head portion 104. Grip portion 103 is connected to head portion 104 at a first end and has a free end that is opposite the first end. As shown in FIG. 4, head portion 104 has a larger width W1 than a width W2 of grip portion 103. Referring back to FIGS. 1 and 2, button 105 and lights 106, 108, 110 extend through openings in housing 102. For example, button 105 activates and deactivates facial brush 100 and lights 106, 108, 110 indicate a status of operation of facial brush 100. Housing 102 is removably connectable to first attachment 112. First attachment 112 has protrusions 114 that extend from a connector 116. First attachment 112 is removably connectable to housing 102, for example, by snap fit, friction fit, magnets, or other connection. Housing 102 houses a controller, for example, a microcontroller unit and printed circuit board that controls operation of facial brush 100 so that button 105 activates and deactivates a motor to rotate first attachment 112 by selectively providing electric current from a battery to the motor. The battery can be a rechargeable battery.

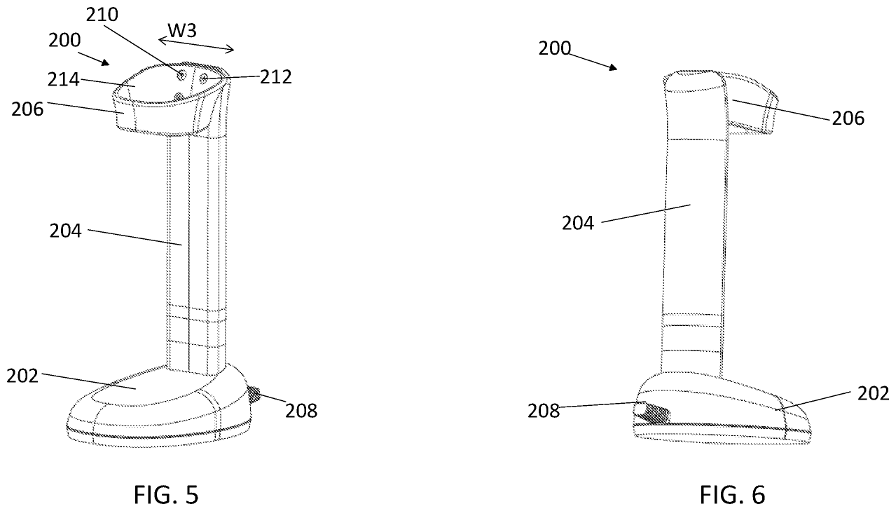

Cradle 200 has a base 202. A support 204 extends upward from base 202. A loop 206 extends outward from support 204. Loop 206 has a width W3 (FIG. 5) that is a smaller size than width W1 of head portion 104. Width W3 of loop 206 is further sized larger than width W2 of grip portion 103 so that grip portion 103 can pass through loop 206. Grip portion 103 passes through loop 206 to position head portion 104 on loop 206 so that loop 206 supports head portion 104 allowing facial brush 100 to hang from cradle 200. Support 204 is sized to have a length L1 so that when facial brush 100 hangs from cradle 200, grip portion 103 has a space S1 between base 202 and grip portion 103. Base 202 has a power cord 208 that is partially shown in FIGS. 1 and 2. Power cord 208 extends into base 202. Power cord 208 is for connecting to an external, electrical power supply.

Referring to FIG. 3, facial brush 100 is removable from cradle 200. Referring to FIG. 4, facial brush 100 has brush electrical contacts 118, 120 that extend through openings in housing 102 on a side that is opposite a side of housing 102 that connects to first attachment 112. Alternatively, brush electrical contacts 118, 120 can be one electrical contact, or more than two electrical contacts. Grip portion 103 is free of electrical contacts at the free end that is opposite the first end.

Referring to FIG. 5, cradle 200 has cradle electrical contacts 210, 212 that extend through an interior 214 of loop 206. Alternatively, cradle electrical contacts 210, 212 can be one electrical contact or more than two electrical contacts. Cradle electrical contacts 210, 212 are positioned so that when facial brush 100 hangs on cradle 200, as shown in FIGS. 1 and 2, cradle electrical contact 210 contacts brush electrical contact 120 and cradle electrical contact 212 contacts brush electrical contact 118. Base 202 is free of electrical contacts.

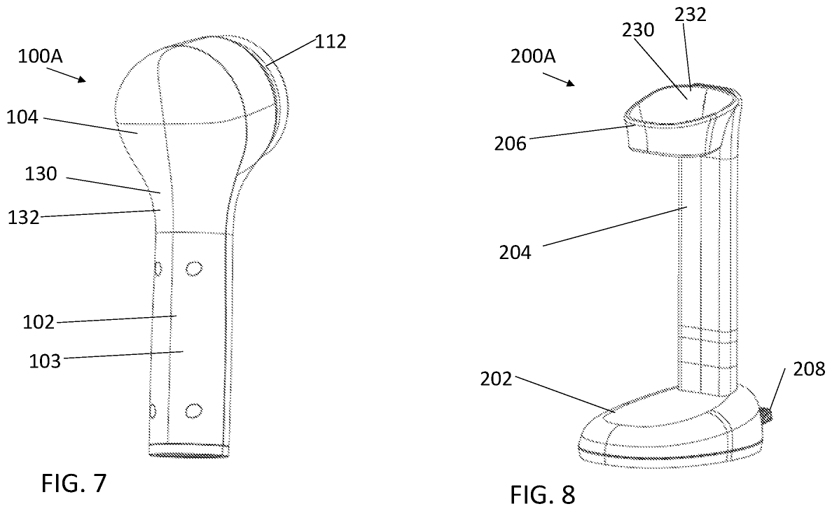

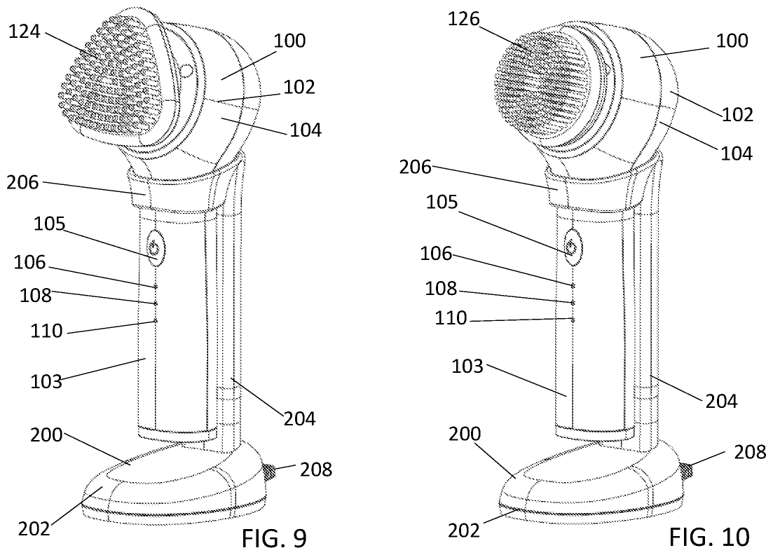

Alternatively, referring to FIGS. 7 and 8, brush 100 and cradle 200 as configured in the present invention can be modified to brush 100A and cradle 200A that use, as an alternative to direct metal-to-metal contact charging, an inductive charging system 130, 230 in which electromagnetic induction provides electricity from cradle 200A to brush 100A without direct metal-to-metal contact. Instead, the electromagnet field that carries the charge is transmitted through respective exterior surfaces 132, 232 of cradle 200A and brush 100A which may be, for example, made of plastic or other non-conductive material. Such inductive charging systems are generally known and are used in such applications as power tools, electric toothbrushes, and medical devices. Accordingly, brush 100A is the same as brush 100 except for replacing brush electrical contacts 118, 120 and the direct metal-to-metal contact charging with inductive charging system 130, 230. Cradle 200A is the same as cradle 200 except for replacing cradle electrical contacts 210, 212 and the direct metal-to-metal contact charging with inductive charging system 130, 230.

During operation, a user connects power cord 208 to a power source, for example, power cord 208 has a plug that connects to an electrical outlet. Power cord 208 conducts electrical current to cradle electrical contacts 210, 212. Alternatively, power cord 208 conducts electrical current to inductive charging system 230 of cradle 200A.

Referring to FIG. 1, when facial brush 100 hangs from cradle 200, cradle electrical contact 210 contacts brush electrical contact 120 and cradle electrical contact 212 contacts brush electrical contact 118 to conduct electrical current from cradle electrical contact 210 to brush electrical contact 120 and cradle electrical contact 212 to brush electrical contact 118 to charge the battery housed in housing 102 of facial brush 100. Alternatively, when facial brush 100A hangs from cradle 200A, electromagnetic induction provides electricity from cradle 200A to brush 100A. The user moves facial brush 100 upward, as shown by arrow A, out of cradle 200 to separate facial brush 100 and cradle 200 for use. Likewise, the user moves facial brush 100A upward, as shown by arrow A, out of cradle 200A to separate facial brush 100A and cradle 200A for use.

As shown in FIG. 3, facial brush 100, 100A can then be used for facial treatment of the user's skin. For example, the user can press button 105 of facial brush 100, 100A so that the controller activates the motor for rotation of first attachment 112 that can be positioned to contact skin of the user's face for cleaning, exfoliating, massaging, moisturizing and/or the like, and then, the user can press button 105 so that the controller deactivates the motor and rotation of first attachment 112 stops. The user moves facial brush 100 to hang from cradle 200 by moving facial brush downward, in a direction opposite to the direction shown by arrow A, into cradle 200 so that grip portion 103 passes through loop 206 to position head portion 104 on loop 206 allowing facial brush 100 to hang from cradle 200. Likewise, the user moves facial brush 100A to hang from cradle 200A by moving facial brush downward, in a direction opposite to the direction shown by arrow A, into cradle 200A so that grip portion 103 passes through loop 206 to position head portion 104 on loop 206 allowing facial brush 100A to hang from cradle 200A. While facial brush 100 hangs from cradle 200, cradle electrical contact 210 contacts brush electrical contact 120 and cradle electrical contact 212 contacts brush electrical contact 118 to conduct electrical current from cradle electrical contact 210 to brush electrical contact 120 and cradle electrical contact 212 to brush electrical contact 118 to charge the battery housed in housing 102 of facial brush 100. Alternatively, when facial brush 100A hangs from cradle 200A, electromagnetic induction provides electricity from cradle 200A to brush 100A.

Referring to FIGS. 7 and 8, facial brush 100, 100A can have interchangeable attachments. The interchangeable attachments can include first attachment 112, a second attachment 124 and a third attachment 126. For example, facial brush 100, 100A can have an adapter that removably connects to a connection portion on each of first attachment 112, second attachment 124 and third attachment 126 so that a user can selectively connect one of first attachment 112, second attachment 124 and third attachment 126 to facial brush 100, 100A at a time. When connected each of first attachment 112, second attachment 124 and third attachment 126 is rotatable when facial brush 100, 100A is selectively activated and deactivated by pressing button 105.

Accordingly, facial brush 100, 100A is electrically powered to treat skin, for example, by cleaning, exfoliating, massaging and/or moisturizing the skin. Facial brush 100, 100A advantageously hangs (i.e., is suspended) from a cradle 200, 200A rather than resting in a hole in a base. Typically, a bottom portion of facial brushes rest in or are held in the base. The base can have electrical contacts for contacting electrical contacts on the facial brush to recharge the facial brush. However, the electrical contacts in the base can get undesirably covered in moisture, dust, lint and the like and/or the hole in the base that itself generally collects undesirable debris, liquid, water and the like. Facial brush 100, 100A that hangs from cradle 200, 200A avoids this.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes can be made and equivalents can be substituted for elements thereof without departing from the scope of the present disclosure. In addition, many modifications can be made to adapt a particular situation or material to the teachings of the disclosure without departing from the scope thereof. Therefore, it is intended that the present disclosure should not be limited to the particular embodiment(s) disclosed as the best mode contemplated, but that the disclosure will include all embodiments falling within the scope of the appended claims.

What is claimed is:

1. A facial brush and a cradle system comprising,
an electrically powered facial brush having at least one moving part that is driven by electrical power and that has a housing, a grip portion and a head portion;
a cradle having a base adapted to rest in a free-standing fashion on a generally flat surface and having a cord for connecting to an external electrical power supply source,
wherein the cradle can support the facial brush in a position in which the facial brush is suspended above the base and the generally flat surface.

2. The facial brush and the cradle system of claim 1, further comprising an electrical charging system for charging at least one electrical battery contained in the facial brush.

3. The facial brush and the cradle system of claim 1, wherein the head portion has a larger width than a width of the grip portion.

4. The facial brush and the cradle system of claim 1, wherein the housing is removably connectable to a first attachment.

5. The facial brush and the cradle system of claim 1, wherein the cradle has a base, a support that extends upward from the base, and a loop that extends outward from the support.

6. The facial brush and the cradle system of claim 5, wherein the loop has a width that is a smaller size than a width of the head portion.

7. The facial brush and the cradle system of claim 6, wherein the width of the loop is sized larger than the width of the grip portion so that the grip portion can pass through the loop to position the head portion on the loop to support the head portion on the loop allowing the facial brush to hang from the cradle.

8. The facial brush and the cradle system of claim 7, wherein the support is sized to have a length so that when the facial brush hangs from the cradle, and wherein the grip portion has a space between the base and the grip portion.

9. The facial brush and the cradle system of claim 2, wherein the electrical charging system comprises at least one brush electrical contact on the facial brush and at least one cradle electrical contact on the cradle, each of the electrical contacts positioned so that when the facial brush is supported by the cradle the at least one cradle electrical contact and the at least one brush electrical contact engage each other for transmitting electrical power from the cradle to the facial brush.

9. The facial brush and the cradle system of claim 2, wherein the electrical charging system comprises an inductive charging system housed internally in the facial brush and the cradle so that when the facial brush is supported by the cradle electrical power is transmitted from the cradle to the facial brush.

10. The facial brush and the cradle system of claim 1, wherein the facial brush has interchangeable attachments.
